(19) United States
(12) Patent Application Publication
(10) Pub. No.: US 2021/0393478 A1
(43) Pub. Date: Dec. 23, 2021

(54) HAND-ATTACHED CONTROLLED ECCENTRIC VIBRATION DEVICE

(71) Applicant: Raja BHATTI, Arlington, TX (US)

(72) Inventor: Raja BHATTI, Arlington, TX (US)

(21) Appl. No.: 17/465,233

(22) Filed: Sep. 2, 2021

Related U.S. Application Data
(63) Continuation-in-part of application No. 15/786,737, filed on Oct. 18, 2017.

(51) Int. Cl. A61H 23/02

(52) U.S. Cl. CPC A61H 23/0263; A61H 2201/0153; A61H 2201/5005; A61H 2201/5007; A61H 2201/0157; A61H 2201/1215

(57) ABSTRACT

A hand-attached controlled eccentric vibration device, configured to be attached to a back of a hand of a first person giving a massage to a second person receiving the massage. The hand-attached controlled eccentric vibration device includes a unit body made of rigid material in a form of a box and comprises a compartment to enclose at least one motor, a controller, and a battery therein. The bottom of the unit body has a curved shape to be fitted with the back of the hand of the first person. Further, the unit body is attached to the back of the hand of the first person by means of a skin attachment part.

This application is a continuation-in-part application of U.S. patent application Ser. No. 15/786,737, filed on Oct. 18, 2017, titled “Hand-Attached Controlled Eccentric Vibration Device,” the full disclosure of which is hereby incorporated by reference and priority of which is hereby claimed.

### FIELD OF THE INVENTION

This invention is a hand-attached controlled eccentric vibration device, configured to be attached on a hand of a person giving a massage for providing an enhanced massage effect, allowing for full skin-to-skin contact between the hand of the person giving the massage and the skin of the person receiving the massage.

### DESCRIPTION OF THE RELATED ART

Presently known hand-attached devices of this type are mounted to the hand using a glove, partial glove, or straps, which interfere with full skin-to-skin contact between the hand of the person giving a massage and the skin of the person receiving the massage. However, the skin-to-skin contact is considered by some to be an important aspect of the massage, and interference with this contact is not favored.

Further, addition of the proper vibration to the hand of the person giving a massage is known to be beneficial and desirable in some circumstances. One of the major benefits of a massage is achieved by the breaking up and dislodging of crystals of lactic acid, which form within muscle tissue under conditions of activity or tension, where the broken-up lactic-acid crystals are then re-dissolved into the blood, which in turn flushes the lactic acid out of the muscle tissue. The massage is thought to both break up the crystals and increase the flushing movement of blood through the targeted muscle tissue, both of which are beneficial actions.

The amount and quality of the vibration applied to and through the hand of the person giving a massage is an important consideration. For example, vibrations in the ultrasonic range might be effective for breaking down crystals, but such fast vibrations cannot be effectively transmitted through the hand of the person giving a massage, because the hand would absorb the ultrasonic energy, causing discomfort or damage to the hand of the person giving the massage, and without transferring any significant benefit to the person receiving the massage. Within the range of intensities and frequencies of vibration that can be applied to and transmitted through the hand (which are all fairly high frequencies in relation to the whole range of possibilities), frequencies at the lower end and at the higher end of the range are considered to be most effective and most comfortable, and therefore most desirable.

Presently known hand-attached devices of this type either contain a large heavy motor, with an eccentric weight, to achieve the desirable amplitudes or intensities of vibration at desirable frequencies or cycle times, or use a smaller motor, which cannot, on their own, provide the desirable intensities and frequencies of vibration, but instead provide more of a buzzing effect.

For example, U.S. Pat. No. 2,018,046 issued to G. A. Wilson on Oct. 22, 1935 for a “Vibrator.” The Wilson patent discloses a vibrator of a general nature, with a rigid casing, an electric motor within the casing, and means driven from the motor adapted to vibrate the casing, where the casing in turn comprises a body portion, within which the motor is positioned, and an extension in the direction of the wrist of the hand upon which it is mounted, with controlling means within the extension adapted to control the rate of rotation of the motor, and where the extension is downwardly inclined with respect to the body of the casing, as well as yielding means adapted to extend about the hand, where the yielding means are also connected to the casing, and means adapted to extend about the hand and connect to the extension.

U.S. Pat. No. 2,287,501 was issued on Jun. 23, 1942 to William A. Thomas, also disclosing a “Vibrator”, and more specifically a self-contained electric hand-vibrator, incorporating a vibratory electric motor and adapted to be mounted on the back of the hand to vibrate the fingers of the wearer, the fingers in turn being applied as massage elements to the portion of the anatomy to be treated. In order to hold the vibrator in position on the hand, a strap or band is provided, to be worn around the hand of the wearer.

U.S. Pat. No. 7,300,409, issued to Robert J. Kopanic, J R. et al. on Nov. 27, 2007, covers a “Therapy Patch.” The therapy patch provides portable massaging devices that can also deliver topical treatment chemicals. The patches can be adhered to the skin via an adhesive layer that is also impregnated with the treatment chemical. Kits are also provided to create a string of linked patches that can be used together or separately, and a microcontroller controls the vibration of the device for optimized massaging effects.

U.S. Publication No. 2008/0216207 was published on Sep. 11, 2008 by Shen-Hai Tsai, disclosing a “Finger Pressing Massage Glove.” The concept provides for a fingertip massaging glove, and particularly a glove massager to facilitate a user in operation according to his preference. The glove massager includes a glove fit out one's hand for vibration; a vibration device enclosed inside of the glove that includes a panel with an interface displayed on a hand back of the glove; and a number of eccentric vibrators connected to the panel by leads. A set of batteries are disposed inside the panel to supplement power to the glove. When the vibrators are powered to vibrate, the affected part of the user can be relieved of pain or soreness.

U.S. Publication No. 2012/0136288, published by Deborah Napier on May 31, 2012, discloses “Heat Massage Gloves.” The heated massage glove comprises a hand covering to envelope a hand of a user, a set of finger segments to accept the fingers of the user, a set of finger massagers attached within the set of finger segments, where the set of finger massagers vibrate and pulse against the set of fingers, a set of hand massagers attached to a backside of the hand covering, wherein the set of hand massagers vibrate and pulse against a backside of the hand, a heating apparatus housed within the hand covering, where the heating apparatus includes a plurality of wires to heat the hand covering, and a control mechanism attached to the backside of the hand, covering wherein the control mechanism that controls the intensity of the set of finger massagers and the set of hand massagers, as well as how intense the heating apparatus heats.

U.S. Publication No. 2014/0243589, disclosing a “Disposable Vibratory Apparatus,” was published on Aug. 28, 2014 by Kinkel Rowan. The dev ice includes a patch enclosing a battery and a vibratory element with a removable, nonconductive tab for turning the apparatus on or off. The apparatus may be applied, directly, to a target area of the human body via an adhesive layer, to provide a vibratory sensation for therapeutic or pleasurable purposes. The vibratory apparatus configuration comprises minimal components within the patch, providing portability and freedom of movement without an external controller or power source.

Lastly, U.S. Publication No. 2017/0036009 was published by Clint Hughes et al. on Feb. 9, 2017, and discloses a “TENS with Vibration and/or Mechanical Muscular Manipulation.” The publication discloses a transcutaneous electrical nerve simulation (“TENS”) device and method using a microcurrent with a carrier signal and a square wave form, combined with vibration and/or mechanical muscular manipulation for promoting the release and disbursement of lactic acid, treating muscle soreness, cramping, or degeneration. The method and nerve simulation device is packaged to require no input from a user, and the user must only apply the sticky electrode pad, featuring a base unit attached on top, to the correct part of the body, and start the preprogrammed sequence of electrical currents, vibration, and/or muscular manipulation. The method involves applying bursts of direct current at higher frequencies for shorter periods of time, followed by lower frequency bursts of electrical current for longer periods of time, combined with a small vibration motor and/or motorized nodes, providing muscular manipulation to certain areas of the body.

There is, accordingly, a need for a device which mounts to the back of the hand in a manner that allows for full skin-to-skin contact, and being of small size and weight, but achieving deeper, slower vibrations from a motor small enough to fit comfortably on the back of the hand.

### SUMMARY OF THE INVENTION

A hand-attached controlled eccentric vibration device, configured to be attached on a back of a hand of a first person to give a massage to a second person, comprises a unit body having a curved surface on a bottom of the unit body, wherein the curved surface is shaped to be fitted on the back of the hand of the first person giving the massage. The unit body is made of rigid material in a form of a box, and comprises a compartment for receiving at least one motor, a controller, and a battery. The at least one motor is adapted to vibrate in response to an application of electric power, and the at least one motor is an Eccentric Rotating Mass (ERM) type electric motor that rotates off-balance to provide vibrations. The battery is adapted to provide an electric power to the at least one motor and the controller regulates the electric power supplied to said motor. The device further includes at least one control button that is installed on the unit body for used for controlling operations of the controller.

Further, the unit body is removably attached to the back of the hand of the first person by a skin attachment part that is attachable on the surface of the unit body that touches the back of the hand of the first person.

A hand-attached controlled eccentric vibration device for use by a first person giving a massage to a second person receiving the massage is also disclosed. In addition to the unit body, the at least one motor, the battery, the controller, and the at least one button, as described above, the device further comprises a skin attachment part on the bottom of the unit body that is used to attach the unit body on the back of the hand of the first person giving the massage, and that when attached, allows a full skin-to-skin contact between the hand of the first person giving the massage and the skin of the second person receiving the massage without additional materials worn by the hand or fingers of the first person giving the massage. The skin attachment part includes more than one layer and is attachable on the back of the hand of the first person by a disposable skin adhesive.

A hand-attached controlled eccentric device is further disclosed. In addition to the unit body, the at least motor, the battery, the controller, and the at least one button, as described above, the device further comprises an attachment part on the bottom of the unit body for attaching the unit body on the back of the hand of the first person giving the massage. The skin attachment part includes a skin patch shaped to be mounted on the back of the hand of the first person giving the massage by an incorporated skin adhesive on a bottom face, and having on a top face a surface adapted to provide a top-facing mounting surface; and an intermediate patch shaped to be mounted on said unit body by an incorporated adhesive on a top face, and having on a bottom face a surface adapted to provide a bottom-facing mounting surface corresponding to the top-facing mounting surface of said skin patch. The skin patch and the intermediate patch are attachable by mounting the bottom-facing mounting surface of the intermediate patch to the top-facing mounting surface of the skin patch, and the skin adhesive is disposable after being used.

In use, the controller regulates the electric power from the battery supplied to the at least one motor in an eccentric manner such as to cause the unit body to vibrate in a specified frequency, and a vibration of the unit body resulting from the operation of the controller is configured to be transferred from the hand of the first person giving the massage to a skin of the second person when a front of the hand of the first person touches the skin of the second person receiving the massage.

### BRIEF DESCRIPTION OF THE DRAWINGS

Various other features and attendant advantages of the present invention will be more fully appreciated when considered in conjunction with the accompanying drawings.

FIG. 1 is a perspective view of a hand-attached controlled eccentric vibration device in accordance with the disclosed embodiments.

FIG. 2 is a perspective view of a hand-attached controlled eccentric vibration device when attached on a back of a hand in accordance with the disclosed embodiments.

FIG. 3 is diagram showing that a hand-attached controlled eccentric vibration device in accordance with the disclosed embodiments is worn by a first person giving a massage to a second person who receives the massage.

FIG. 4 is an exploded perspective view of a hand-attached controlled eccentric vibration device in accordance with the disclosed embodiments, in which a skin attachment part is disclosed.

FIG. 5 is an exploded perspective view of a hand-attached controlled eccentric vibration device in accordance with the disclosed embodiments, in which a skin attachment part is disclosed in more details.

FIG. 6 is a diagram illustrating that a skin patch of a hand-attached controlled eccentric vibration device is removably attachable to a back of a hand in accordance with the disclosed embodiment.

FIG. 7 is a perspective view of a hand-attached controlled eccentric vibration device in accordance with the disclosed embodiments showing how the hand-attached controlled eccentric vibration device is attached to a back of a hand.

FIG. 8 is a schematic hidden-line view showing internal components of a hand-attached controlled eccentric vibration device in accordance with the disclosed embodiments.

FIG. 9 is a schematic hidden-line view of a hand-attached controlled eccentric vibration device in accordance with the disclosed embodiments, having two motors mounted in matching orientation inside the device.

FIG. 10 is a perspective view of a hand-attached controlled eccentric vibration device of the invention in accordance with the disclosed embodiments, having a display separate from multiple control buttons.

FIG. 11 is a perspective view of a hand-attached controlled eccentric vibration device in accordance with the disclosed embodiments, having a touch-sensitive display incorporating multiple control buttons.

FIG. 12 is a schematic view of a hand-attached controlled eccentric vibration device in accordance with the disclosed embodiments, having a remote unit.

FIG. 13 is a schematic view of a hand-attached controlled eccentric vibration device in accordance with the disclosed embodiments, having an external power source.

FIG. 14 is a flowchart illustrating a method using a hand-controlled eccentric vibration device to apply a vibrational massage to a person who receives the massage in accordance with the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

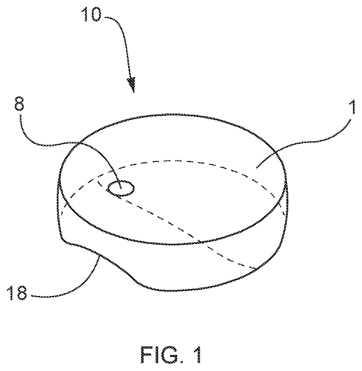

FIG. 1 illustrates a hand-attached controlled eccentric vibration device 10 in accordance with the disclosed embodiment. As shown in the figure, hand-attached controlled eccentric vibration device 10 includes a unit body 1 that has a curved bottom surface 18. The hand-attached controlled eccentric vibration device 10 provides at least one control button 8 on the unit body 1. In a simple embodiment, a single control button 8 could function as a simple on-off switch, or could provide more controls based on multiple pushes or holding of the button. The at least one button 8 may be an on/off button to turn on and off the device 10.

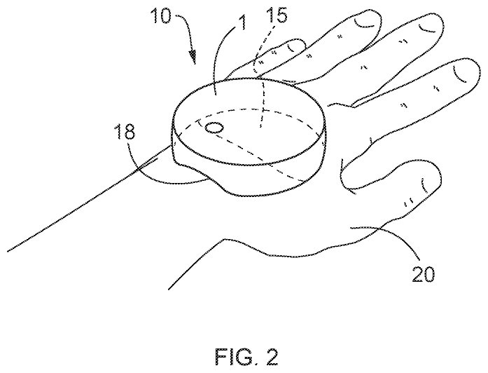

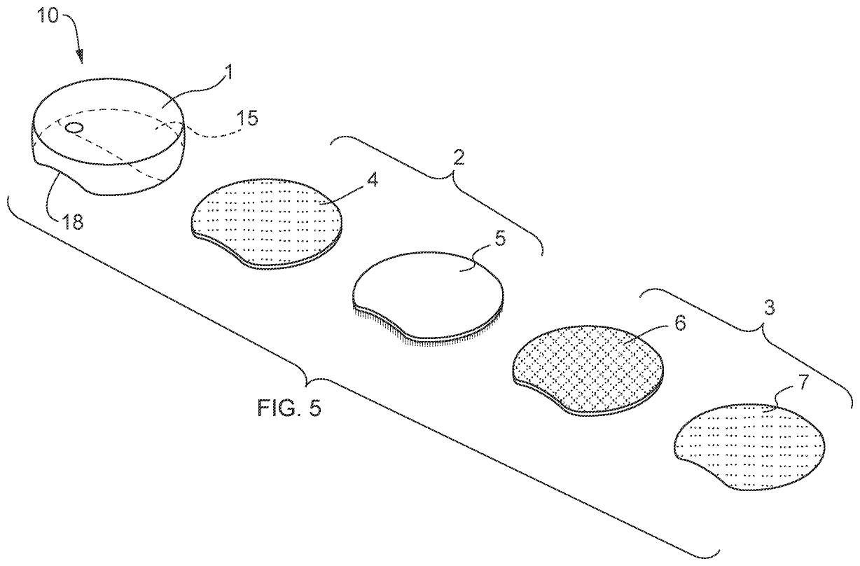

FIG. 2 is a schematic diagram showing that hand-attached controlled eccentric vibration device 10, when in use, is mounted on a back 22 of a hand 20 of a first person giving a massage to a second person (30, shown in FIG. 5).

The unit body 10 is removably attached to the back 22 of the hand 20 of the first person giving a massage without any glove, or bands, or any other material that would cover the skin of the palm-side of the hand or would cover the fingers. By not covering the palm-side of the hand or the fingers, the hand-attached controlled eccentric vibration device 10 allows a full skin-to-skin contact between the hand 20 of a first person giving a massage and a skin of a second person (30, shown in FIG. 5) receiving the massage.

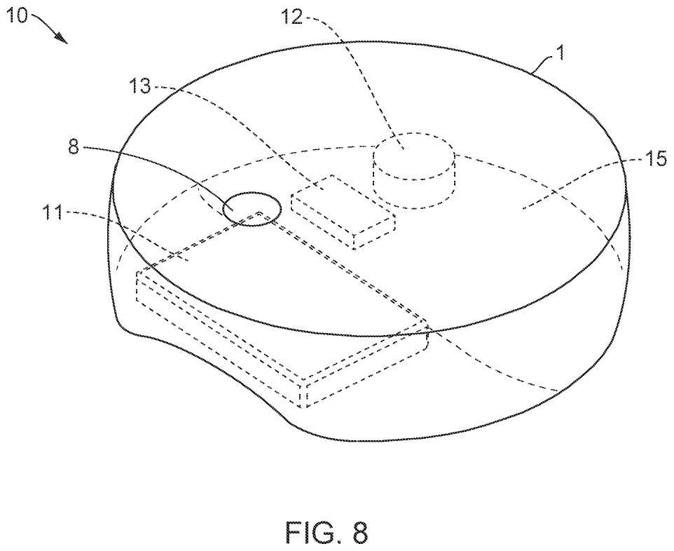

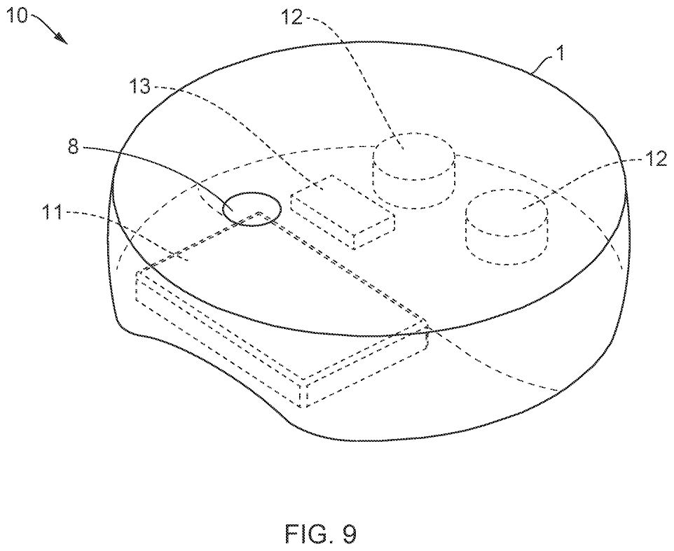

In accordance with the preferred embodiments, the hand-attached controlled eccentric vibration device 10 may be made of materials suitable to form a box with a compartment 15 big enough to enclose at least one motors, a battery, and a controller, as shown in FIGS. 8-9, which will be described in details later. The material may be rigid materials, such as plastic or wood, or soft materials such as rubbers or silicone materials. The curved bottom surface 18 of device 10 is shaped in order to fit with a shape of the back 22 of the hand 20 of the first person giving a massage. The curved bottom surface 18 allows the device 10 to be attached comfortably and more securely on the back 22 of the hand 20 when it is in use.

In one disclosed embodiment, the curved bottom surface 18 is configured to fit only on the back of the hand 20 of a first person giving a massage, and not for other parts of the body of the first person or any part of the body of a second person who receives the massage from the first person. For example, the curved bottom surface 18 does not allow the device 10 to be attached to the shoulder or the chest of the person using the device. The subsequent components are arranged to compliment the curved bottom surface 18 in attaching to the back of the hand 20. Therefore, the first person attaches the hand-attached controlled eccentric device 10 on the back of his/her hand and touches a skin of the second person with a front (i.e., palm) of his/her hand to give the second person a massage. No other stuff, such as gloves, band, or any other material which would cover the skin of the palm-side (i.e., front side) of the hand or would cover the fingers of the first person. Such a manner allows a skin-to-skin contact between the first person and the second person.

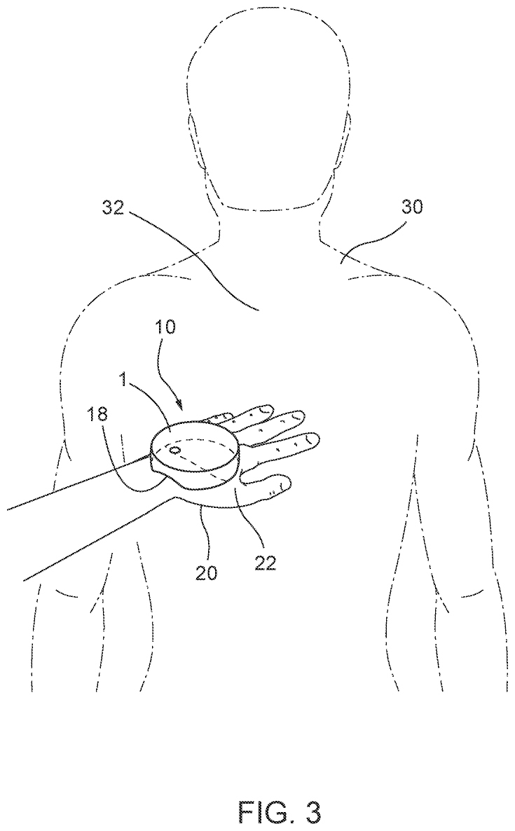

FIG. 3 shows an illustrative view showing that the device 10 is only attached on the back 22 of the hand of the first person giving the massage. The first person then gives the massage to the second person 30 by touching the skin 32 of the second person 30 with the front (i.e., the palm-side) of his/her hand.

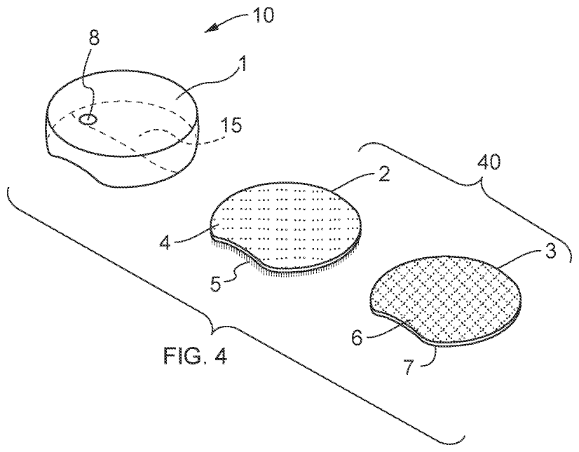

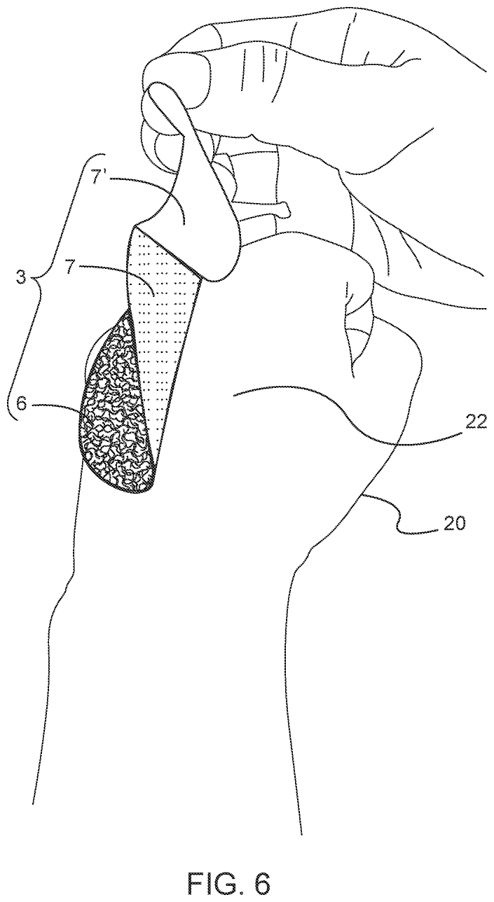

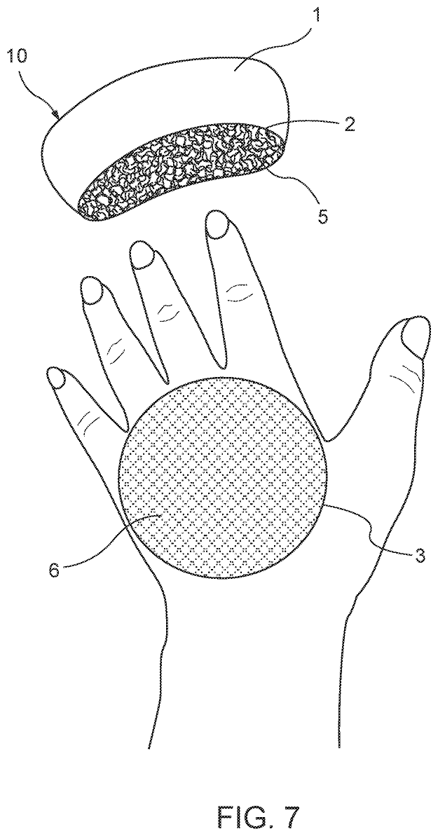

In accordance with the disclosed embodiments, the hand-attached controlled eccentric vibration device 10 is removable, replaceable, and reposition-able attachable to the back 22 of the hand 20 by means of skin attachment patches 2 and 3, as shown in FIGS. 6 and 7. The details of a skin attachment part 40 including patches 2 and 3 will be described in FIGS. 3 and 4.

In the disclosed embodiments of FIGS. 3 and 4, along with FIGS. 6 and 7, the skin attachment part 40 is adhered to the curved bottom surface 18 of the unit body 1 and includes a skin patch 3 and an intermediate patch 2.

In FIG. 3, the intermediate patch 2 comprises an adhesive 4 on a top side and a layer of attachment hooks 5 on a bottom side. The skin patch 3 comprises a layer of attachment loops 6 on a top side and a skin adhesive 7 on a bottom side. The skin patch 3 is mounted to the back 22 of the hand 20 by means of the skin adhesive 7 and the intermediate patch 2 is mounted to the curved bottom surface 18 of the unit body 1 by means of the adhesive 4. The skin patch 3 and the intermediate patch 2 are removably attached to each other using known methods such as the provision of the layer of attachment hooks 5 on the bottom of the intermediate patch 2 and the layer of attachment loops 6 on the top of the skin patch 3, to provide the known hook-and-loop type of removable, replaceable, and reposition-able attachment.

The preferred embodiments do not limit the attaching manner between the intermediate patch 2 and the skin patch 3 to be only the hoops-and-loops style. Other attaching manner, such as using buckles, buttons, clinches, or fastening belt so that the intermediate patch 2 and the skin patch 3 can be removably attached together is also applicable.

FIG. 4 illustrates the skin attachment part in accordance with the disclosed embodiments in more details. In this figure, the bottom 18 of the unit body 1 has a curved surface to be fitted to the shape of the back of a hand. The adhesive 4 and the skin adhesive 7 are separated elements from the intermediate patch 2 and the skin patch 3, which may be applied by the person giving a massage when this person starts to attach the device 10 on the back of his/her hand. The adhesive 4 and the skin adhesive 7 may be double-sided adhesive or an adhesive tape or any appropriate materials that can be attached and removed from the bottom 18 of the unit body 1 and the back of the hand and has sufficient strength to hold the device 10 in place on the back of the hand.

The skin adhesive 7 should be one that will adequately hold to an active hand, and that will not irritate the skin of the back of the hand. In order to provide an adequate hold, the skin adhesive 7 might be one that is more easily removed with a non-irritating solvent or removed by the application of a type and a direction of force that is unlikely to be applied in normal use, such as a simultaneous twisting and lifting force. For example, the skin adhesive 7 may be a double-sided adhesive or an adhesive tape with enough adhesive force to hold the hand-attachment eccentric device 10 in position on the back of the hand. As shown in FIG. 6, a non-sticky protection film 7′ covers the skin adhesive 7 before it is mounted on the back of the hand. When the device 10 is ready to be used, the user would remove the non-sticky protection film 7′ so that the skin adhesive 7 can be attached on the back 22 of the hand 21, leaving the layer of attachment loops 6 on the top of the skin adhesive 7.

As shown in FIG. 7, the intermediate patch 2 is attached on the bottom surface 18 of the device 10 through the adhesive 4, leaving the layer of attachment hooks 5 appeared on the bottom of the patch 2. The layer of attachment hooks 5 is removably attached to the layer of attachment loops 6. Therefore, when the intermediate patch 2 and the skin patch 3 are attached by the layers of attachment loops 6 and attachment hooks 5, the unit body 1 of the device 10 can be mounted securely on the back 22 of the hand 20.

The adhesive 4 may also be a double-sided adhesive or an adhesive tape to attach the intermediate patch 2 to the unit body 1. In this case, the skin attachment part 3 is removable from unit body 1. Alternatively, the adhesive 4 may be a glue, for example, that are applied on the other side of the layer of attachment hooks 5 of the intermediate patch 2. Therefore, the intermediate patch 2 may be permanently attached on the bottom 18 of the unit body 1 by the adhesive 4 or appropriate adhesive materials. Further, as described above, the intermediate patch 2 and the skin patch 3 are removably attached to each other by means of the layer of attachment hooks 5 and the layer of attachment loops 6. Accordingly, when the person wearing the device 10 to give a massage to another person would like to take a break, he/she can simply remove the unit body 1 along with the intermediate patch 2 off the skin patch 3 but leaves the skin patch on the back of his/her hand, as shown in FIG. 7. Once the break is over, one can re-attached the intermediate patch 2 along with the unit body to the skin patch 3.

In accordance with the disclosed embodiments, the skin adhesive 7 is disposable after use. In some embodiments, the adhesive 4 may permanently attach the intermediate patch 2 to the bottom 18 of the unit body 1. In alternative embodiments, the adhesive 4 may be removed from the bottom 18 of the unit body 1 and is disposable after use.

Referring to FIG. 8, the unit body 1 includes the compartment 15. Inside the compartment 15 are one motor 12, a battery 11, and a controller 13. The motor 12 provide the vibrating actions of the hand-attached controlled eccentric vibration device 10. In accordance with the disclosed embodiments, the motor 12 may be an Eccentric Rotating Mass (ERM) type electric motor or a Linear Resonance Actuator (LRA) type electronic motor.

A battery 11 supplies the electric force for operating the motor or motors 12. The battery might be a flat lithium-polymer rechargeable battery of the type used in cellphones as is illustrated, or might another type or form of battery, such as a coin-cell battery or an AAA-sized battery. An ultra-capacitor could also function as a battery, as is known in the art.

A controller 13 manages the amount of power from the battery 11 that is supplied to the motor 12. In embodiments having just one motor 12, the controller 13 supplies the electric power in timed pulses calibrated to provide specific, desired vibrational characteristics. Any motor 12 fitted into the unit body 1 must necessarily be small, and therefore will have high natural vibrational frequency and resonance, or a series of such frequencies and resonances. In order to achieve more desirable lower vibrational frequencies, and in order to achieve desirable modifications to the timing or rhythm of the vibration, the controller 13 supplies power to the motor 12 in pulses calibrated to provide the desired effect. By providing or withholding the power in pulses coordinated with the natural vibrational frequencies and resonances, plus the starting, stopping, and other characteristics of the motor 12, the hand-attached controlled eccentric vibration device 10 can produce changes in intensity and timing of the vibration, with higher intensity and slower timing being most likely desired.

FIG. 9 illustrates a hand-attached controlled eccentric vibration device 10 with at least two motors 12 in accordance with the disclosed embodiments. In the disclosed embodiments, the interaction among the motors can be controlled by the controller 13 to produce desirable vibrational effects. Two or more motors 12 can also be mounted inside the compartment 15 of the unit body 1 so that the line or plane of their major vibrational forces are aligned, are opposing, or are oblique.

According to the principle of superposition of waves, when two or more propagating waves of the same type are incident on the same point, the resultant amplitude at that point is equal to the vector sum of the amplitudes of the individual waves. When a crest of a wave meets a crest of another wave of the same frequency at the same point, then the amplitude is the sum of the individual amplitudes, in a phenomenon known constructive interference. If a crest of one wave meets a trough of another wave, then the amplitude is equal to the difference in the individual amplitudes, in the phenomenon known as destructive interference.

Constructive interference occurs when the phase difference between the waves is an even multiple of 1π (180°) such as 2π (360°); destructive interference occurs when the difference is an odd multiple of π (180°). An intermediate phase difference causes a displacement of intermediate magnitude. Where the two or more propagating waves are all of equal constant frequency, then the changes of amplitude will occur in a repeating cycle directly corresponding to the original frequency. Where the frequencies of the two or more propagating waves are different from one another, then the crests and troughs of the waves have more complex relationships and interactions, and the changes of amplitude will occur in a different, more complex cycle that does not directly correspond to any of the original frequencies. This more complex cycle is sometimes referred to as “beats.”

The hand-attached controlled eccentric vibration device 10 in accordance with the disclosed embodiments utilizes the principle of superposition of waves to obtain overall vibrational amplitudes and frequencies different from those of the individual contributing motors 12. The hand-attached controlled eccentric vibration device 10 of these embodiments can obtain overall vibrations of amplitude or intensity, and of frequency or timing, of desired values, with higher intensity and slower timing being most likely desired. The controller 13 manages the contributing amplitudes, frequencies, and phases of each individual motor 12 by controlling the electric power provided to each individual motor, so that the desired overall vibrations can be obtained. In accordance with the disclosed embodiments, the vibrational wave generated by the motors 12 should have intensities and amplitudes strong enough so that the vibrational wave can be transferred from the back of a first person giving a massage to a second person who receives the massage. The motors 12 may generate vibrational waves in different intensities and speeds by the control of the controller 13. For example, the motors 12 may generate three gear speeds, as follows:

1700 rpm±10% at low speed (gear 35%);

3600 rpm±10% at medium speed (gear 75%); and

4800 rpm±10% at high speed (gear 100%).

Referring to FIG. 9, even where two identical motors 12 are placed in alignment with each other, more intense vibration can be achieved by the controller 13, ensuring that the force from the two motors add together for an increase in intensity, rather than canceling each other for a decrease in intensity. Also, two identical motors can be operated at different speeds, which would allow for a pulsing of intensity with slower timing, because the forces of the motors will intermittently add and cancel each other.

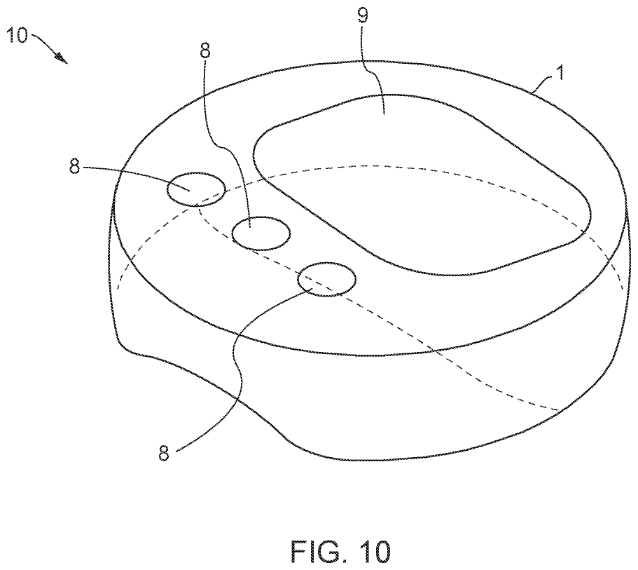

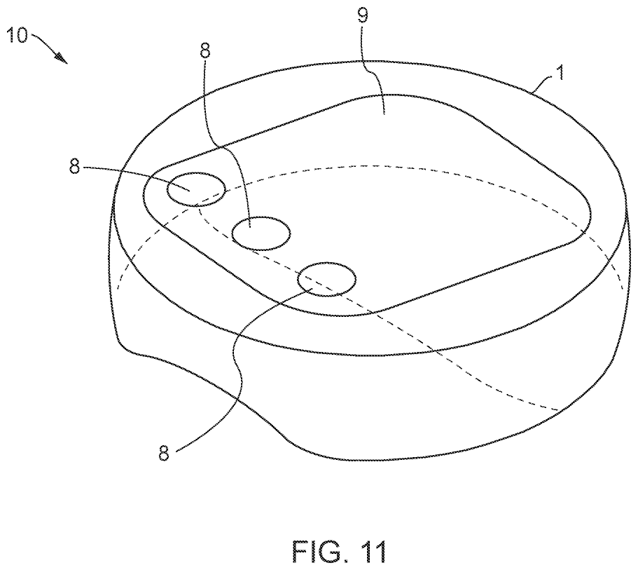

Referring now to FIGS. 10 and 11, the hand-attached eccentric vibration device 10 may comprise more than one control buttons 8. FIG. 10 further shows that the device 10 is provided with a display 9. Such a display 9 might be of more use where, in addition to displaying the operational parameters, additional features such as timers, event counters, or accelerometers are also incorporated. The optional display 9 might cover a part of, or essentially the whole top face, of the unit body 1, as illustrated in FIG. 10. Where a touch-sensitive display 9 is used, the control button or buttons 8 can be implemented as a component of the display, as shown in FIG. 11.

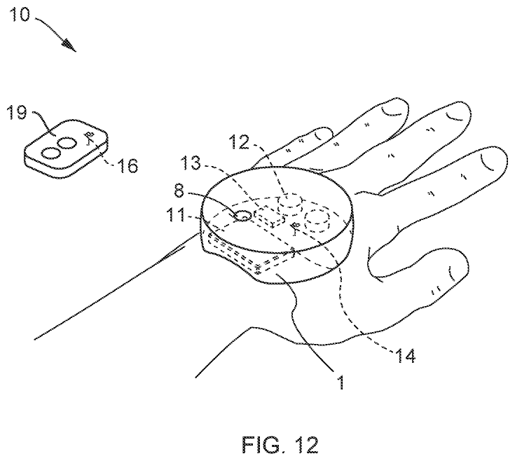

Referring to FIG. 12, an alternative embodiment of the hand-attached controlled eccentric vibration device 10 also provides a remote unit 19 for remote control of the operating parameters, such as on-off state, intensity, and timing of the vibration of the hand-attached controlled eccentric vibration device. The remote unit 19 might be used by the person giving a massage, or by the person receiving the massage. The remote unit 19 communicates wirelessly with the unit body 1 through a unit antenna 14 incorporated into the unit body 1, and a corresponding remote antenna 16 incorporated into the remote unit 19.

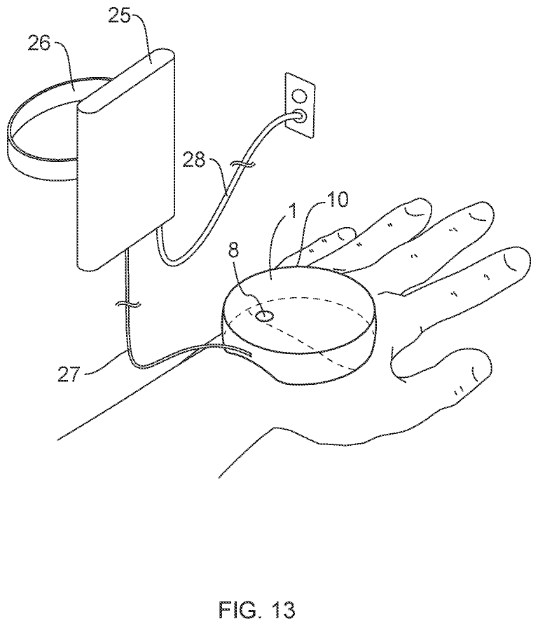

Referring to FIG. 13, another alternative embodiment of the hand-attached controlled eccentric vibration device 10 also provides an external power source 25 to provide either supplemental power, or the main power for operating the hand-attached controlled eccentric vibration device 10. The external power source can provide a strap 25 for attachment, which would likely be an attachment to the upper arm or to the forearm of the person giving the massage. The external power source 25 provides power to the unit body 1 through a power cable 27, which should be flexible and connected with sufficient looseness or play to allow full movement of the hand and wrist. The external power source 25 can be recharged from another source, such as mains electricity, through a recharging cord 28, which can be removed or retracted during use of the hand-attached controlled eccentric vibration device 10.

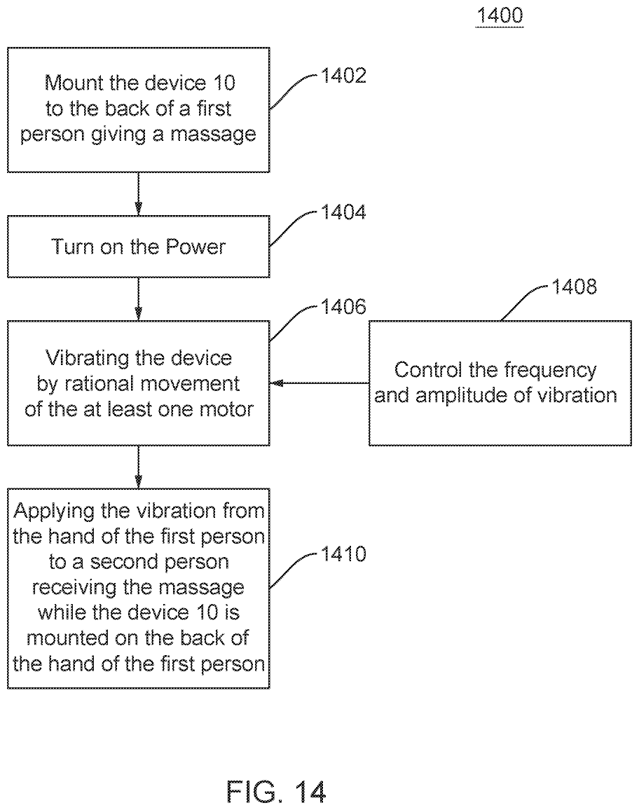

FIG. 14 depicts a flowchart 1400 showing a method for applying vibration generated by the hand-attached controlled eccentric device 10 from a first person giving a massage to a second person receiving the massage in accordance with the disclosed embodiments. As described above, the device 10 is attached to the back of the hand of the first person and is not attached to any part of the body of the second person who receives the massage.

Step 1402 executes by attaching the hand-attached controlled eccentric device 10 on the back of the hand of the first person. The attachment is completed by mounting the skin adhesive 7 of the skin attachment part 40 on the back of the hand of the first person, as shown in FIG. 6.

Step 1404 executes by turning on the device 10 and, if applicable, selecting an intensity level of vibration of the device. The step engages the device to supply power from the battery 11 to the at least one motor 12.

After step 1404, the at least one motor 12 installed within the compartment 15 of the device 10 generates vibrational waves so that the device 10 vibrates, as executed by step 1406. The intensity of the vibrations of the device is controlled by controller 13 that controls an amount of the power supplied from the battery 11 to the at least one motor 12 to vary the vibrations of the device 10, as executed by step 1408.

Next, step 1410 executed by applying the vibrations from the hand of the first person to the body of the second person receiving the massage. The application of vibration can be done by the first person touching a skin of the second person with the front of his/her hand, while still wearing the device 10 on the back of his/her hand, as shown in FIG. 3. With the help of vibrations of the device 10, the first person would be able to provide a deeper and enhanced massage effect on the second person.

Based on the above, the unit body 10 in accordance with the disclosed embodiments is attached to the back 22 of the hand 20 of the first person giving a massage without any glove, or bands, or any other material that would cover the skin of the palm-side of the hand or would cover the fingers. Further, the curved bottom surface 18 of device 10 provides a comfortable fitting of the unit body 1 on the back 22 of the hand 20. The skin attachment part 40 allows the unit body 10 to be removably attached on the back 22 of the hand 20. The hand-attached controlled eccentric vibration device 10 allows a full skin-to-skin contact between the hand of a first person giving a massage and a skin of a second person receiving the massage and provides a deeper massage.

Many other changes and modifications can be made in the system and method of the present invention without departing from the spirit thereof. The rights to the present invention are limited only by the scope of the appended claims.

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

What is claimed is:

1. A hand-attached controlled eccentric vibration device, configured to be attached on a back of a hand of a first person to give a massage to a second person, comprising:
a unit body having a curved surface on a bottom of the unit body, wherein the curved surface is shaped to be fitted on the back of the hand of the first person giving the massage, the unit body being made of rigid material in a form of a box, and comprising a compartment for receiving at least one motor, a controller, and a battery;
the at least one motor installed in the compartment of the unit body, adapted to vibrate in response to an application of electric power, and the at least one motor being an Eccentric Rotating Mass (ERM) type electric motor that rotates off-balance to provide vibrations;
the battery installed within the compartment of the unit body, adapted to provide electric power to the at least one motor;
the controller installed in the compartment of the unit body, adapted to regulate the electric power supplied to said motor; and
at least one control button that is installed on the unit body for use for controlling operations of the controller;
wherein in use, said controller regulates the electric power from the battery supplied to the at least one motor in an eccentric manner such as to cause the unit body to vibrate in a specified frequency, and wherein a vibration of the unit body resulting from the operation of the controller is configured to be transferred from the hand of the first person giving the massage to a skin of the second person when a front of the hand of the first person touches the skin of the second person receiving the massage, and
wherein the unit body is removably attached to the back of the hand of the first person by a skin attachment part that is attachable on the surface of the unit body that touches the back of the hand of the first person.

2. The hand-attached controlled eccentric vibration device of claim 1, wherein the battery is a rechargeable battery.

3. The hand-attached controlled eccentric vibration device of claim 1, wherein the skin attachment part comprises:
a skin patch shaped to be mounted on the back of a hand by an incorporated skin adhesive on a bottom face, and having on a top face a surface adapted to provide a top-facing mounting surface; and
an intermediate patch shaped to be mounted on said unit body by an incorporated adhesive on a top face, and having on a bottom face a surface adapted to provide a bottom-facing mounting surface corresponding to the top-facing mounting surface of said skin patch,
wherein the skin patch and the intermediate patch are attachable by mounting the bottom-facing mounting surface of the intermediate patch to the top-facing mounting surface of the skin patch, and
wherein the skin adhesive of the skin patch is disposable after being used.

4. The hand-attached controlled eccentric vibration device of claim 1, wherein the skin attachment part comprises:
(i) a skin patch shaped to be mounted on the back of a hand by an skin adhesive on a bottom face, and having on a top face a surface adapted to provide a top-facing mounting surface with attachment loops; and
(ii) an intermediate patch shaped to be mounted on said unit body by an adhesive on a top face, and having on a bottom face a surface adapted to provide a bottom-facing mounting surface with attachment hooks, corresponding to the top-facing mounting surface of said skin patch,
wherein the skin patch and the intermediate patch are attachable by mounting the attachment loops of the intermediate patch to the attachment hooks of the skin patch, and
wherein the skin adhesive of the skin patch is disposable after being used.

5. The hand-attached controlled eccentric vibration device of claim 1, further comprising an external power source or a portable power pack.

6. The hand-attached controlled eccentric vibration device of claim 1, further comprising an external power source having a strap for attachment to the arm of the person giving the massage, having a power cable adapted to provide power to said unit body, and having a recharging cord adapted to accept power from mains electricity.

7. A hand-attached controlled eccentric vibration device, for use by a first person giving a massage to a second person receiving the massage, said device comprising:
a unit body having a curved surface on a bottom of the unit body, wherein the curved surface is shaped to be fitted on the back of the hand of the first person giving the massage, the unit body being made of rigid material in a form of a box, and comprising a compartment for receiving at least one motor, a controller and a battery;
the at least one motor installed in the compartment of the unit body, adapted to vibrate in response to the application of electric power, wherein the at least one motor is an Eccentric Rotating Mass (ERM) type electric motor that rotates off-balance to provide vibrations;
the battery installed in the compartment of the unit body, adapted to provide electric power for said at least one motor;
the controller installed in the compartment of the unit body, adapted to regulate the electric power supplied to said motor;
at least one control button mounted on said unit body, adapted to be used for controlling the operation of said controller;
a skin attachment part on the bottom of the unit body for attaching the unit body on the back of the hand of the first person giving the massage, and that when attached, allows a full skin-to-skin contact between the hand of the first person giving the massage and the skin of the second person receiving the massage without additional materials worn by the hand or fingers of the first person giving the massage, wherein the skin attachment part includes more than one layer and is attachable on the back of the hand of the first person by a disposable skin adhesive;
wherein in use, said controller regulates the electric power from the battery supplied to the at least one motor in an eccentric manner such as to cause the unit body to vibrate in a specified frequency, and wherein a vibration of the unit body resulting from the operation of the controller is configured to be transferred from the hand of the first person giving the massage to a skin of the second person when a front of the hand of the first person touches the skin of the second person receiving the massage.

8. The hand-attached controlled eccentric vibration device of claim 7, wherein the skin attachment part comprises:
a skin patch shaped to be mounted on the back of a hand by the disposable skin adhesive on a bottom face, and having on a top face a surface adapted to provide a top-facing mounting surface; and
an intermediate patch shaped to be mounted on said unit body by an incorporated adhesive on a top face, and having on a bottom face a surface adapted to provide a bottom-facing mounting surface corresponding to the top-facing mounting surface of said skin patch,
wherein the skin patch and the intermediate patch are attachable by mounting the bottom-facing mounting surface of the intermediate patch to the top-facing mounting surface of the skin patch, and
wherein the skin adhesive is disposed after being used.

9. The hand-attached controlled eccentric vibration device of claim 7, wherein the skin attachment part comprises:
a skin patch shaped to be mounted on the back of a hand by the disposable skin adhesive on a bottom face, and having on a top face a surface adapted to provide a top-facing mounting surface with attachment loops; and
an intermediate patch shaped to be mounted on said unit body by an incorporated adhesive on a top face, and having on a bottom face a surface adapted to provide a bottom-facing mounting surface with attachment hooks, corresponding to the top-facing mounting surface of said skin patch,
wherein the skin patch and the intermediate patch are attachable by mounting the attachment loops of the intermediate patch to the attachment hooks of the skin patch, and
wherein the disposable skin adhesive of the skin patch is disposed after being used.

10. The hand-attached controlled eccentric vibration device of claim 7, wherein the battery is a rechargeable battery.

11. The hand-attached controlled eccentric vibration device of claim 7, further comprising an external power source or a portable power pack.

12. The hand-attached controlled eccentric vibration device of claim 7, further comprising an external power source having a strap for attachment to the arm of the person giving the massage, having a power cable adapted to provide power to said unit body, and having a recharging cord adapted to accept power from mains electricity.

13. A hand-attached controlled eccentric vibration device, for use by a first person giving a massage to a second person receiving the massage, said device comprising:
a unit body having a curved surface on a bottom of the unit body, wherein the curved surface is shaped to be fitted on the back of the hand of the first person giving the massage, the unit body being made of rigid material in a form of a box, and comprising a compartment for receiving at least one motor, a controller and a battery;
the at least one motor installed in the compartment of the unit body, adapted to vibrate in response to the application of electric power, wherein the at least one motor is an Eccentric Rotating Mass (ERM) type electric motor that rotates off-balance to provide vibrations;
the battery installed in the compartment of the unit body, adapted to provide electric power for said at least one motor;
the controller installed in the compartment of the unit body, adapted to regulate the electric power supplied to said motor;
at least one control button mounted on said unit body, adapted to be used for controlling the operation of said controller; and
a skin attachment part on the bottom of the unit body for attaching the unit body on the back of the hand of the first person giving the massage, wherein the skin attachment part includes:
a skin patch shaped to be mounted on the back of the hand of the first person giving the massage by an incorporated skin adhesive on a bottom face, and having on a top face a surface adapted to provide a top-facing mounting surface; and
an intermediate patch shaped to be mounted on said unit body by an incorporated adhesive on a top face, and having on a bottom face a surface adapted to provide a bottom-facing mounting surface corresponding to the top-facing mounting surface of said skin patch,
wherein the skin patch and the intermediate patch are attachable by mounting the bottom-facing mounting surface of the intermediate patch to the top-facing mounting surface of the skin patch, and
wherein the skin adhesive is disposable after being used;
wherein in use, said controller regulates the electric power from the battery supplied to the at least one motor in an eccentric manner such as to cause the unit body to vibrate in a specified frequency, and wherein a vibration of the unit body resulting from the operation of the controller is configured to be transferred from the hand of the first person giving the massage to a skin of the second person when a front of the hand of the first person touches the skin of the second person receiving the massage.

14. The hand-attached controlled eccentric vibration device of claim 13, wherein the mounting surfaces of the skin patch and the intermediate patch includes attachment hooks.

15. The hand-attached controlled eccentric vibration device of claim 13, wherein the battery is a rechargeable battery.

16. The hand-attached controlled eccentric vibration device of claim 13, further comprising an external power source or a portable power pack.

17. The hand-attached controlled eccentric vibration device of claim 13, further comprising an external power source having a strap for attachment to the arm of the person giving the massage, having a power cable adapted to provide power to said unit body, and having a recharging cord adapted to accept power from mains electricity.

18. The hand-attached controlled eccentric vibration device of claim 13, wherein the controller controls the power supplied by the battery to the at least one motor to change an intensity of the vibration of the unit body and the at least one button is used to select the intensity of the vibration of the unit body.

19. The hand-attached controlled eccentric vibration device of claim 13, wherein the controller controls an activation of the at least one motor and the at least one button is used to control a timer of the vibration of the unit body.

20. The hand-attached controlled eccentric vibration device of claim 13, wherein the controller is a central processing unit (CPU).
